(19) United States
(12) Patent Application Publication
(10) Pub. No.: US 2013/0097413 A1
(43) Pub. Date: Apr. 18, 2013

(54) COMPUTING DEVICE AND METHOD FOR CONTROLLING A STARTUP CURRENT OF A STORAGE SYSTEM

(71) Applicant: CHIH-HUANG WU, Tu-Cheng (TW)

(72) Inventor: CHIH-HUANG WU, Tu-Cheng (TW)

(73) Assignee: HON HAI PRECISION INDUSTRY CO., LTD., Tu-Cheng (TW)

(21) Appl. No.: 13/590,429

(22) Filed: Aug. 21, 2012

(30) Foreign Application Priority Data
Oct. 18, 2011 (TW) 100137752

(51) Int. Cl. G06F 1/32; G06F 9/00

(52) U.S. Cl. 713/2

(57) ABSTRACT

A method for controlling a startup current of a storage system using a computing device, the computing device detects a current of each storage device of the storage system when the storage system is turned on, and calculates the power drawn by each storage device according to the current of each storage device. If a sum of powers drawn by all the storage devices is greater than a predetermined value, the computing device turns off the storage system and determines a startup sequence of the storage devices and a startup time of each storage device. The startup time of each storage device is stored in a storage unit.

### BACKGROUND

1. Technical Field

The embodiments of the present disclosure relate to storage system control, and particularly to a computing device and method for controlling a startup current of a storage system.

2. Description of related art

With the increasing demands for large data storage, more and more storage devices (e.g., hard disk drives) are added to a storage system. If too many storage devices are started up simultaneously, a startup current of the storage system may be too large, resulting in the power supply being unstable. A higher wattage power supply may solve this problem. However, the higher wattage power supply may be expensive, and the power consumption of the storage system may increase.

### BRIEF DESCRIPTION OF THE DRAWINGS

FIG. 1 is a block diagram of one embodiment of a computing device.

FIG. 2 is a block diagram of one embodiment of function modules of a current controlling system in FIG. 1.

FIG. 3 is a flowchart of one embodiment of a method for controlling a startup current of a storage system using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

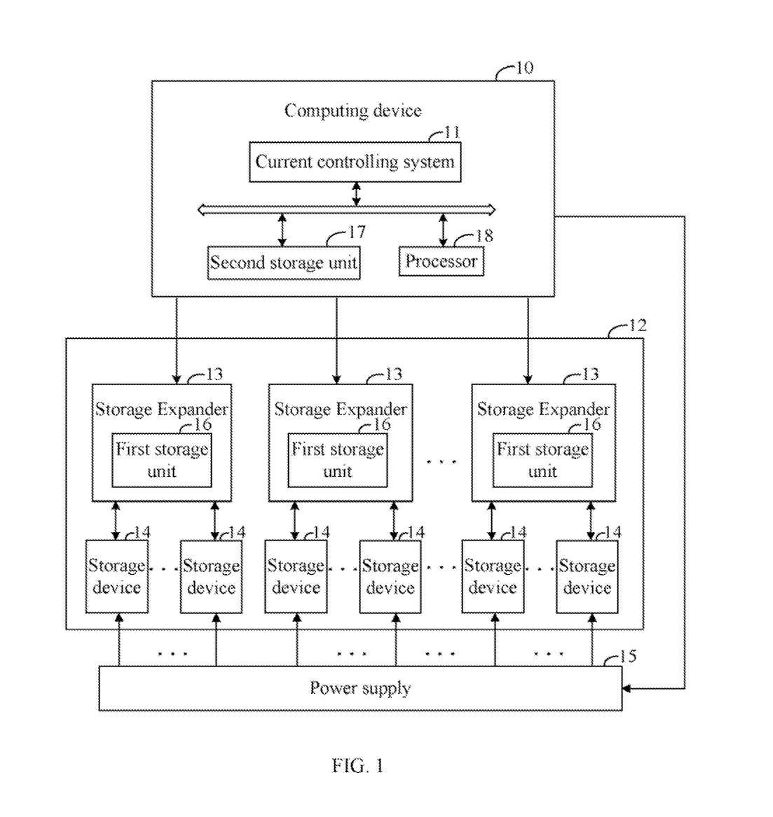

FIG. 1 is a block diagram of one embodiment of a computing device 10. In the embodiment, the computing device 10 includes a current controlling system 11 for controlling a startup current of a storage system 12. The storage system 12 includes a plurality of storage expanders 13 and storage devices 14. The computing device 10 is connected to the storage expanders 13 and a power supply 15. Each of the storage expanders 13 is connected to multiple storage devices 14, and includes a first storage unit 16 (e.g., a flash memory). The power supply 15 provides power to the storage devices 14. Each of the storage devices 14 may be a magnetic or optical storage device, such as a hard disk drive, an optical drive, or a tape drive.

In the embodiment, the computing device 10 further includes a second storage unit 17 and at least one processor 18. The second storage unit 17 may be a dedicated memory, such as an erasable programmable read only memory (EPROM), a hard disk driver (HDD), or flash memory. In some embodiments, the second storage unit 17 may also be an external storage device, such as an external hard disk, a storage card, or other data storage medium.

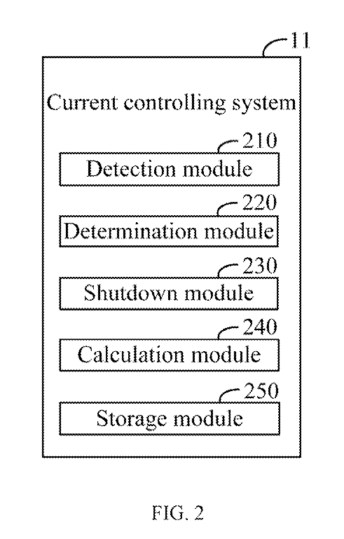

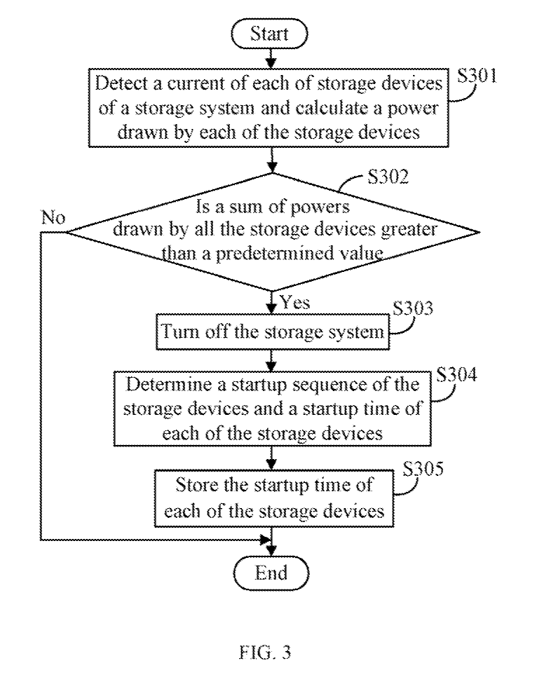

FIG. 2 is a block diagram of one embodiment of function modules of the current controlling system 11 in FIG. 1. The current controlling system 11 includes a detection module 210, a determination module 220, a shutdown module 230, a calculation module 240, and a storage module 250. The modules 210-250 may comprise computerized code in the form of one or more programs that are stored in the second storage unit 17. The computerized code includes instructions that are executed by the at least one processor 18, to provide the aforementioned functions of the current controlling system 11. A detailed description of the functions of the modules 210-250 is given below in reference to FIG. 3.

FIG. 3 is a flowchart of one embodiment of a method for controlling a startup current of the storage system 12 using the computing device 10 in FIG. 1. Depending on the embodiment, additional steps may be added, others removed, and the ordering of the steps may be changed.

When the storage system 12 is turned on, in step S301, the detection module 210 detects a current of each of the storage devices 14 provided by the power supply 15, and calculates a power drawn by each of the storage devices 14 according to the current of each of the storage devices 14. In one embodiment, the detection module 210 detects the current of each of the storage devices 14 via a serial port (e.g., an RS-232 port). The power drawn by each storage device 14 is calculated as a product of the current and a voltage of the storage device 14. The voltage of the storage device 14 is a known value, such as 12 volts, for example.

In step S302, the determination module 220 determines whether a sum of powers drawn by all the storage devices 14 is greater than a predetermined value, such as 4800 watts. If the sum of the powers drawn by all the storage devices 14 is greater than the predetermined value, the power supply 15 cannot provide sufficient power to the storage system 12. In one embodiment, the predetermined value is less than or equal to a rated power of the power supply 15. For example, the rated power of the power supply 15 is 4800 watts and the predetermined value is 4600 watts. If the sum of the powers drawn by all the storage devices 14 is less than or equal to the predetermined value, the process ends.

If the sum of the powers drawn by all the storage devices 14 is greater than the predetermined value, in step S303, the shutdown module 230 turns off the storage system 12.

In step S304, the calculation module 240 determines a startup sequence of the storage devices 14 and a startup time of each of the storage devices 14, to ensure that the sum of the powers drawn by all the storage devices 14 is less than or equal to the predetermined value when the storage system 12 is turned on. In one embodiment, the calculation module 240 divides the storage devices 14 into a plurality of groups. A sum of rated powers of each group of the storages devices 14 is less than or equal to the rated power of the power supply 15. When the storage system 12 is turned on, the groups are started up sequentially. For example, the storage devices 14 are divided into four groups consisting of group A, group B, group C, and group D. Each group needs 30 seconds to start up. The startup sequence of the four groups may be determined as group A, group B, group C, group D. The startup times of group A, group B, group C, and group D may be determined as 0 second, 30 seconds, 60 seconds, and 90 seconds respectively. The startup time (0 second, 30 seconds, 60 seconds, or 90 seconds) is a time delay relative to the time the storage system 12 is turned on. According to the startup sequence and the startup times, group A is started up when the storage system 12 is turned on. Upon lapse of 30 seconds, group B is started up. Upon lapse of 60 seconds, group C is started up. Upon lapse of 90 seconds, group D is started up. When a certain group (e.g. group A) is started up, all the storage devices 14 of the group are started up at the same time.

In step S305, the storage module 250 stores the startup time of each of the storage devices 14 into the storage unit 16 of a corresponding storage expander 13, and controls each of the storage devices 14 to start up according to the startup time when the storage system 12 is restarted. For example, one of the storage expanders 13 is connected to three storage devices 14. Accordingly, the storage module 250 stores the startup times of the three storage devices 14 into the storage unit 16 of the storage expander 13. In one embodiment, each of storage expanders 13 is allocated to a specific IP address. The storage module 250 stores the startup time of each of the storage devices 14 according to the IP address.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling a startup current of a storage system being executed by a processor of a computing device, the storage system comprising a plurality of storage devices, the method comprising:
detecting a current of each of the plurality of storage devices when the storage system is turned on, and calculating a power drawn by each of the plurality of storage devices according to the current of each of the plurality of storage devices, wherein the current is provided by a power supply connected to the computing device;
determining whether a sum of powers drawn by all the plurality of storage devices is greater than a predetermined value;
turning off the storage system upon condition that the sum of the powers drawn by all the plurality of storage devices is greater than the predetermined value;
determining a startup sequence of the plurality of storage devices and a startup time of each of the plurality of storage devices, to ensure that the sum of the powers drawn by all the plurality of storage devices is less than or equal to the predetermined value when the storage system is turned on; and
storing the startup time of each of the plurality of storage devices, and controlling each of the plurality of storage devices to start up according to the startup time when the storage system is restarted.

2. The method of claim 1, wherein the predetermined value is less than or equal to a rated power of the power supply.

3. The method of claim 1, wherein the plurality of storage devices are divided into a plurality of groups, and the groups are determined to be started up sequentially.

4. The method of claim 3, wherein a sum of rated powers of each group of the storages devices is less than or equal to a rated power of the power supply.

5. The method of claim 1, wherein the startup time of a storage device is stored into a storage unit of a storage expander that is connected to the storage device.

6. A computing device, comprising:
a storage unit;
at least one processor; and
a current controlling system comprising one or more programs that are stored in the storage unit and executed by the at least one processor, the one or more programs comprising instructions to:
detect a current of each of storage devices of the storage system when the storage system is turned on, and calculate a power drawn by each of the plurality of storage devices according to the current of each of the plurality of storage devices, wherein the current is provided by a power supply connected to the computing device;
determine whether a sum of powers drawn by all the plurality of storage devices is greater than a predetermined value;
turn off the storage system upon condition that the sum of the powers drawn by all the plurality of storage devices is greater than the predetermined value;
determine a startup sequence of the plurality of storage devices and a startup time of each of the plurality of storage devices, to ensure that the sum of the powers drawn by all the plurality of storage devices is less than or equal to the predetermined value when the storage system is turned on; and
store the startup time of each of the plurality of storage devices, and control each of the plurality of storage devices to start up according to the startup time when the storage system is restarted.

7. The computing device of claim 6, wherein the predetermined value is less than or equal to a rated power of the power supply.

8. The computing device of claim 6, wherein the plurality of storage devices are divided into a plurality of groups, and the groups are determined to be started up sequentially.

9. The computing device of claim 8, wherein a sum of rated powers of each group of the storages devices is less than or equal to a rated power of the power supply.

10. The computing device of claim 6, wherein the startup time of a storage device is stored into a storage unit of a storage expander that is connected to the storage device.

11. A non-transitory computer-readable storage medium storing a set of instructions, the set of instructions capable of being executed by a processor of a computing device to implement a method for controlling a startup current of a storage system, the method comprising:
detecting a current of each of storage devices of the storage system when the storage system is turned on, and calculate a power drawn by each of the plurality of storage devices according to the current of each of the plurality of storage devices, wherein the current is provided by a power supply connected to the computing device;
determining whether a sum of powers drawn by all the plurality of storage devices is greater than a predetermined value;
turning off the storage system upon condition that the sum of the powers drawn by all the plurality of storage devices is greater than the predetermined value;
determining a startup sequence of the plurality of storage devices and a startup time of each of the plurality of storage devices, to ensure that the sum of the powers drawn by all the plurality of storage devices is less than or equal to the predetermined value when the storage system is turned on; and
storing the startup time of each of the plurality of storage devices, and controlling each of the plurality of storage devices to start up according to the startup time when the storage system is restarted.

12. The storage medium of claim 11, wherein the predetermined value is less than or equal to a rated power of the power supply.

13. The storage medium of claim 11, wherein the plurality of storage devices are divided into a plurality of groups, and the groups are determined to be started up sequentially.

14. The storage medium of claim 13, wherein a sum of rated powers of each group of the storages devices is less than or equal to a rated power of the power supply.

15. The storage medium of claim 11, wherein the startup time of a storage device is stored into a storage unit of a storage expander that is connected to the storage device. Page 11 of 12
